(19) United States
(12) Patent Application Publication
(10) Pub. No.: US 2011/0079467 A1
(43) Pub. Date: Apr. 7, 2011

(54) Side of ladder accessory

(76) Inventor: Ronald E. Mares, Williamsburg, CO (US)

(21) Appl. No.: 12/587,220

(22) Filed: Oct. 5, 2009

(51) Int. Cl. E06C 5/32

(52) U.S. Cl. 182/129

(57) ABSTRACT

This accessory is adapted for connecting to the side rails of ladders, step ladders and scaffolding. The embodiment of these connecting brackets are designed to hold a tool box at the side of the ladder by engaging the leg of the ladder in two brackets that are tightened by an all thread bolt together. These two brackets also have another bracket that rides on them, all are uniquely interlocked together. This last bracket is named a hanger bracket, having two pins protruding from it, the top one is a hanger pin, the other, angle pin as it adjusts the tool box to the angle of the ladder, the tool box is hung over the head of the hanger pin and into a hole in the tool box and adjusted with the angle pin. The tool box holds a gallon of paint, space for tools, a side tool bar, a roller pan holder. All can be used at one time on a ladder or scaffold. These brackets can be placed at any point on a ladder, step ladder, or scaffold, as there are special brackets that fit inside the ladder brackets that make this adjustment. This also makes them another unique part of this accessory.

### BACKGROUND OF THE INVENTION

This invention relates to ladders, scaffold, particularly attachment to ladders.

### FIELD OF THE INVENTION

Step ladders and extension ladders are sets of rungs and steps between the side rails. Most of the prior art relates to the steps when an accessory is attached to the ladder, most of the prior art does not adapt well for the normal use of ladders and the ability to use the accessory for any other then a specific task and not well in most cases even at that, as most are cumbersome to use, have many braces that are attached to a step that takes space from the craftsman and are difficult to install or remove if not dangerous in the upper part of the ladder.

U.S. Pat. No. 5,505,302: The tool box is on top of a step ladder which is an inconvenient place as reaching and looking over the top or under other tools to get a tool while standing below it.

U.S. Pat. No. 3,842,936: This compartment box is set in the step ladder on the step which takes the area away from the craftsman to work actually no better that U.S. Pat. No. 5,505,302 except it has compartments.

U.S. Pat. No. 5,582,269: A tray fastened to the top of the ladder which is complex and difficult.

U.S. Pat. No. 6,536,590: Tool bucket fastened to ladder rung of ladder.

U.S. Pat. No. 5,191,954: The paint can and connections are connected to the rung or step of the ladder which is not a good idea. The connections to the side prevent the worker from moving the pan to an up or down position, which is very awkward and time consuming.

The problem with much of the prior art is that ladders have a need for accessories that provide an area that gives additional space to work. Easily accessible at a location beside them, easy to move up or down a ladder or completely remove to another area or to another location on the ladder.

This invention is the embodiment of brackets that can hold to the leg of a ladder, these two brackets are named the short bracket and the long bracket they are connected with an all thread bolt they slide up or down on the leg attach to the legs of scaffolding, and with special formed brackets that have pins that make it possible to install them into these brackets. A third formed bracket is the hanger bracket that slides the length of the long bracket it has two pins that hold the tool box adjust to the angle of the ladder. The tool box can hold a paint can and other tools, a roller pan holder, and tool bar, all this being made possible by a combination of these special formed brackets, that are all put together in a combination that makes them one unitized bracket. The brackets are formed to connect the all thread bolt to hold to the ladder, protect the ladder and the bolt with tabs that are formed in the two short and long brackets.

### OPERATION OF INVENTION

1. The tool box and accessories are attached to the ladder by placing the short bracket on the back of the main leg of the ladder, and the long bracket on the front of it, whether it is a step ladder or extension ladder and tightening the all thread bolt tight.

2. The short bracket is made to slide inside the long bracket, slide the hanger bracket into the long bracket, tighten the set screw on the hanger bracket putting the hanger pin up.

3. You can now raise, or lower, or place the bracket on the ladder that you would like including from the front of the ladder to the rear. You can hang the tool box at anytime, even before adjusting the height. You may want to place paint or heavy items after you have the height you want. You can have a gallon of paint and roller pan holder at the same time.

4. The operation of this invention is made so that it can be applied to the ladder by putting the short bracket on the back of the ladder leg tightening the all thread bolt through the long bracket tight.

5. The long bracket is a special bracket as it is formed around the short bracket, and this long bracket has another special bracket attached by forming in the same manner as the long bracket is formed around the short bracket. The long bracket has a divot at the end to be sure that the hanger bracket does not accidentally fall off, even though it also has a set screw in it.

6. These brackets can be slid up or down on the leg by slightly loosening the all thread bolt. The hanger bracket can move from the front side of the ladder to the back side of the ladder.

7. The hanger bracket has two pins protruding from it. The top pin has a big head that fits through a hole in the tool box and the shaft of it slides into a slot and the other pin fits into one of the angle slots that adjust the tool box to a horizontal position. With the tool box in this position, it will hold a gallon paint can and storage for other tools. It can have a tool bar on the side and a roller pan holder that fits across the tool box, and even with the front of the ladder. The painter can pour his paint and use his roller while on the ladder, spackle, caulk, etc.

8. A carpenter with a nail gun, nails, bar-hammer on a step ladder or just to hold his tool up off the floor or next to the ceiling or a drapery hanger, this is good for many trades.

9. This inventions lets the craftsman change work from either side of the ladder to the other side by removing the tool box by simply lifting off of the hanger pin, then loosening the all thread bolt, and putting it on the other side. Remove the hanger bracket and replace with the hanger pin on top.

10. The same brackets can be used on scaffolding legs in the same manner, except there are special brackets that have a pin that fits into the slots provided in the ladder brackets that allow for the conversion from a rectangular leg to fit on the round leg of a scaffold.

### SUMMARY OF INVENTION

This invention is an accessory for ladders, step ladders, or scaffolding. It operates at any height of the ladder from the first step to the top step, on either side of the ladder. It is a conventional tool box, or a tool box that will hold a paint can and accommodate a roller pan for paint at the same time, or many other tools for many trades and craftsmen.

It is not connected to the steps or rungs it is attached to the side of the ladder, First attach the connecting brackets with the hanger bracket, set the tool box over the hanger pin. The aligning pin will hold it in a horizontal position. This is the easiest tool accessory for a ladder that has been made.

It has a total of eight parts including the tool box, pan holder, scaffold brackets and set screws. It will take three minutes to install or three minutes to remove, as the drawing shows the embodiment of the brackets and their relation to each other and in the special forming of the brackets.

The embodiment of the third bracket, which is again formed around the first two leg brackets holding the two pins that connect to the tool box, thus the name “hanger bracket”, as it has two pins; one to hold the tool box, and the other pin aligns it in a horizontal position.

This bracket is again, special as it can slide from the front of the ladder to the rear the length of the long bracket the long bracket also has divots that keep the hanger bracket from sliding off the back side of the ladder

These brackets are also made so that they may be used with scaffolding in the same way that the brackets are able to hold to a ladder as these special made brackets with pin and key in both of the brackets so that two semi circular brackets may be placed one in each bracket and held in place by the pins and key that were made for them. These special brackets are fashioned that in a half circle there are two bulges too the inside meaning that each bracket will have two areas of contact These ladder brackets can also be made for larger ladders, such as the fire departments Again, this tool is easy to use and easy to move. The drawing will show the special embodiment of the brackets in relation that each is a contributor to the unified action of the brackets. When a craftsman sees the units together and how they are formed to work together no mater what trade they are in they will not want to be without it.

### SPECIFICATION

1. This invention is made of eight main parts, mainly two opposing type brackets and all thread tightening bolt that pulls these two brackets together around a ladder leg or scaffolding leg. The scaffold leg will have the special brackets that convert from ladder to scaffold that are secured to the ladder brackets by locking pins.

2. The main brackets are specially made in that the long bracket is formed around the short bracket. They can slide towards each other or back when you use the all thread bolt which tightens in the short bracket. The long bracket end has a smooth shank and stays in that position.

3. The unique part of these brackets is that there is still another bracket that is formed to fit around the long bracket This bracket is called the hanger bracket in that it has two pins protruding from it one is the hanger pin the other is the angle pin, the reason for the name hanger bracket, it is placed on the long bracket at any time and has a thumb screw to keep it in the desired location, the long bracket also has divots at the end to keep this bracket from coming off of the end of it by accident.

4. These brackets are very unique as the first two brackets are able to clamp onto and slide up or down the ladder leg and are held together by the forming around the short bracket by the long bracket. These connecting brackets can move up or down the leg of the ladder. The hanging bracket has two pins; one is the hanging pin, the other is the angle pin. These together make a unified bracket that has a purpose of holding the two pins, that the tool box or other objects that can be connected and slide to any position.

5. The tool box is then connected to the top hanger pin and aligned on the angle pin to be held in a horizontal position by placing the hole in the tool box over the hanger pin and sliding down into a slot, aligning with one of the several angle slots that relate to the angle of the ladder with the Angle pin.

6. The tool box is sized to allow a gallon of paint to set inside of the box and be tightened in by bolts on the side of the box, leaving the extra space for the other tools and, a tool bar to holder for small tools that fit on the edge of the tool box. The tool box also has many slots along the top edge on both sides so that the roller pan holder may fit into the slots downward into the tool box. The tool box can carry a gallon of paint and have a roller pan at the same time.

7. The hanger bracket system is able to be removed and placed on the opposite side of the ladder in the exact same operation, except to reverse the hanging bracket pin. So that the hanger pin is on the top so that the tool box is hung over it and the angle pin in the slot that is relative to the angle of the ladder.

### BRIEF DESCRIPTION OF THE DRAWINGS

FIG. 1 is a perspective view of the present invention attached to a ladder being attached At the top and able to be placed at any position on the side of the ladder and not dependent On a rung or step.

FIG. 3 is a perspective view of the present invention attached to a scaffold leg. FIG. 3 and FIG. 4 showing the opposite views of attachments.

FIG. 5 is a perspective view with the tool box mounted on the brackets a view attached to a scaffold leg. With the paint pan holder attached across the tool box.

FIG. 7. is a perspective view of the paint pan holder across the tool box and extended over the end of the tool box, making room for the paint can. to be placed FIG. 7 22

FIG. 7 FIG. 8 FIG. 9 showing the travel distance of the long bracket, that the hanger bracket Holding the tool box can travel from the front of the leg to the back side of the leg.

### DETAILED DESCRIPTION OF THE PREFERRED EMBODIMENT

1. The present invention comprising of several pieces of metal formed and making these special designed brackets the preferred embodiment: And another special designed bracket an alternate to the preferred embodiment. First two brackets, a short bracket the other the long bracket both brackets having 3 sides each bracket having a longer side than the other two sides of each bracket, the long bracket the long leg formed or wrapped around the long sides of the short bracket making a channel for the long bracket to slide in FIG. 14 1 and 2 and FIG. 14 3 bracket wrapped around the edges of bracket 1, each bracket is wrapped around enough that it is not excessively tight so that they can easily slide and be contained in the channels, The top and bottom corners of each bracket notched FIG. 14 39 so the formed edges can pass by the other bracket and the hanger bracket can also pass, except where the long bracket is embossed. The scope of the invention is of the special design of the brackets. as the design of the brackets will not let them separate and the all thread keeps them together that makes it possible for many trades and more convenient use of a tool box on a ladder. 27 The alternate embodiment, The hanging bracket that is between the primary brackets including the all thread bolt and the connection of the hanging pin to the tool box. Now referring to the drawings.

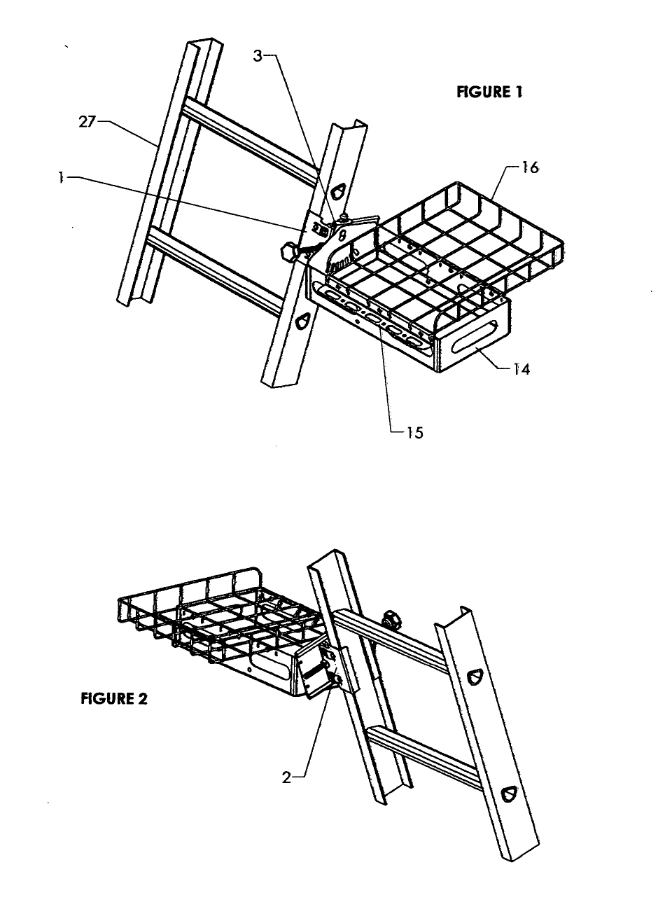

Referring now to FIG. 1 1 showing the long bracket on the leg of a conventional ladder 27 with the tool box 14 attached by the formed hanger bracket 3, the roller pan holder 16 on the top of the tool box. The tool bar 15 on the edge of the tool box 14 Fastened through the tool bar and slanted down into the toolbox.

Referring to FIG. 2 2 showing the short bracket attached to the same leg of the ladder as FIG. 1 1 but on the back side of the ladder completing the desired operation, by the tightening of the brackets with the all thread bolt FIG. 4 5 the difference of the two brackets is the length of the legs that work together to accomplish the task of holding firm to brackets to the ladder.

The long leg of the long bracket being formed around the edges of the long leg of the short bracket being tightened by the all thread bolt holding the brackets tight to the leg of the ladder this is the description of the preferred embodiment referring to in claim 8

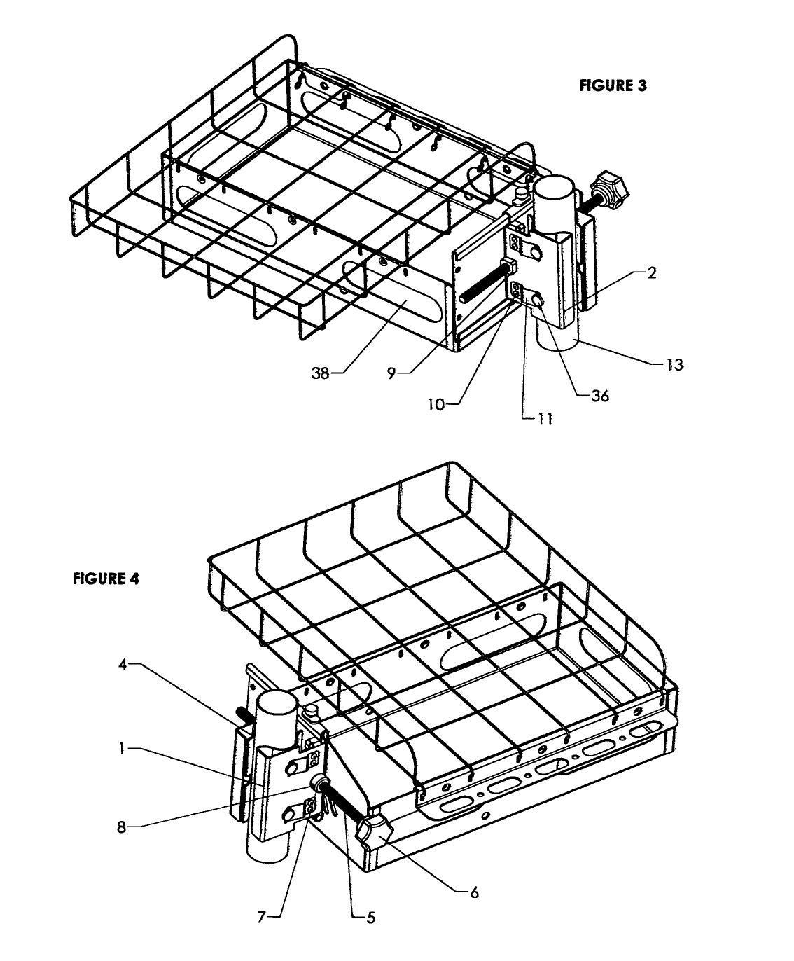

Referring to FIG. 3 2 the short bracket being tightened on the pre formed scaffold bracket FIG. 13 4 onto the scaffold leg FIG. 3 13, The brackets as in claims also having a pre formed scaffold bracket as in it FIG. 13 4 they being installed by placing them into the formed long and short brackets by using the scaffold pins FIG. 3 36 for each scaffold bracket the pins 36 being held by a clip 11 and the clips by rivets 10. the scaffold brackets being tightened by the all thread bolt 5. The all thread bolt being shown through the short bracket tightening through the weld nut 9. and the hand holes being shown 38. there are 5 such holes that can be used for accessory's, or hand holds

Referring to FIG. 4 4 The scaffold brackets are formed in a special way by a half circle With two half circles protruding from the half circle so that each bracket has two areas of contact with the scaffold leg FIG. 13 4 meaning that each scaffold bracket has four areas of good contact the short and long brackets have relative holes for the all thread bolt FIG. 4 5 the all thread bolt is stationary in the long bracket as there are lock collars 7 on the sides of the long bracket 1 and is tightened through the weld nut FIG. 3 9, the lock collars have set screws FIG. 4 8 the hand knob 6 makes it easy to tighten the brackets the tool bar is on the side of the tool box. The tines of the paint pan holder go through the tool bar and down the inside of the tool box.

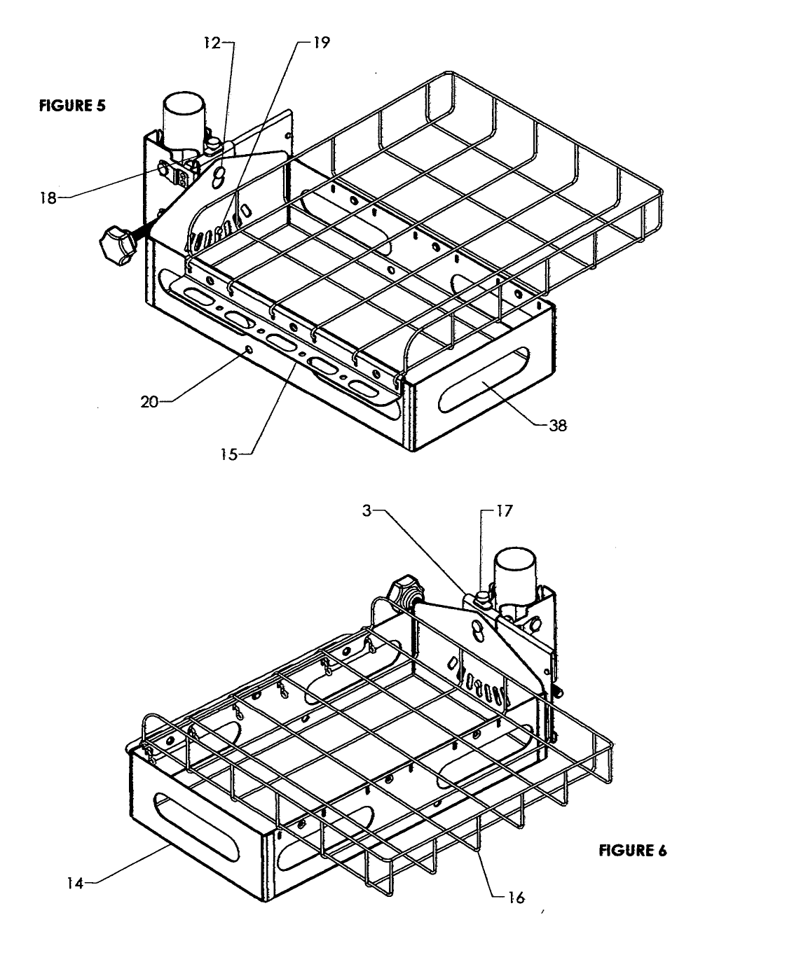

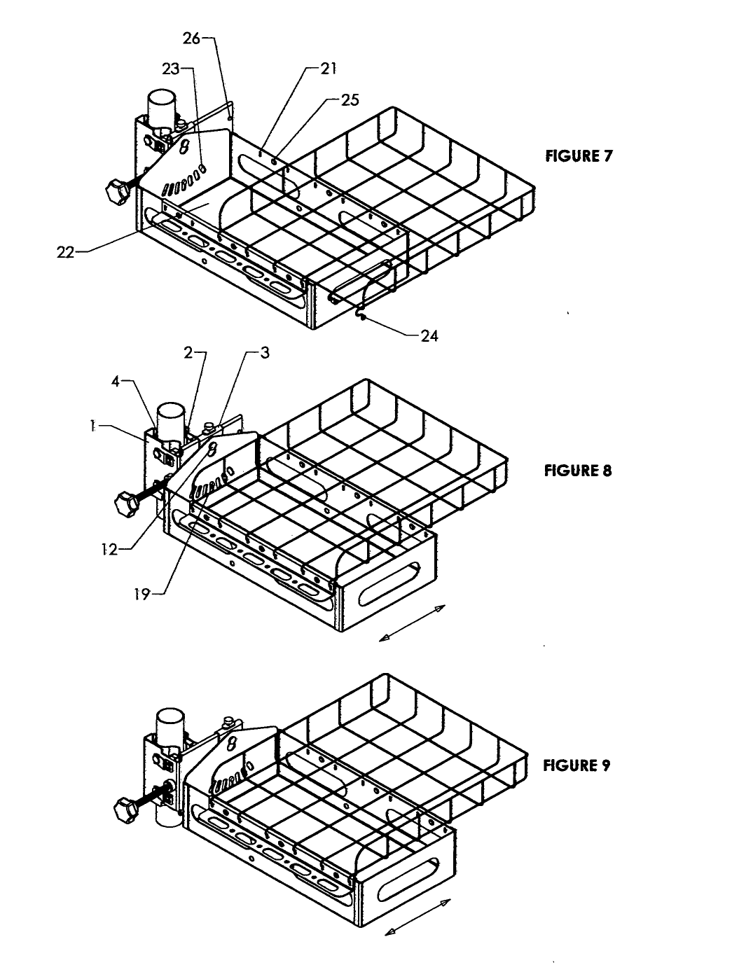

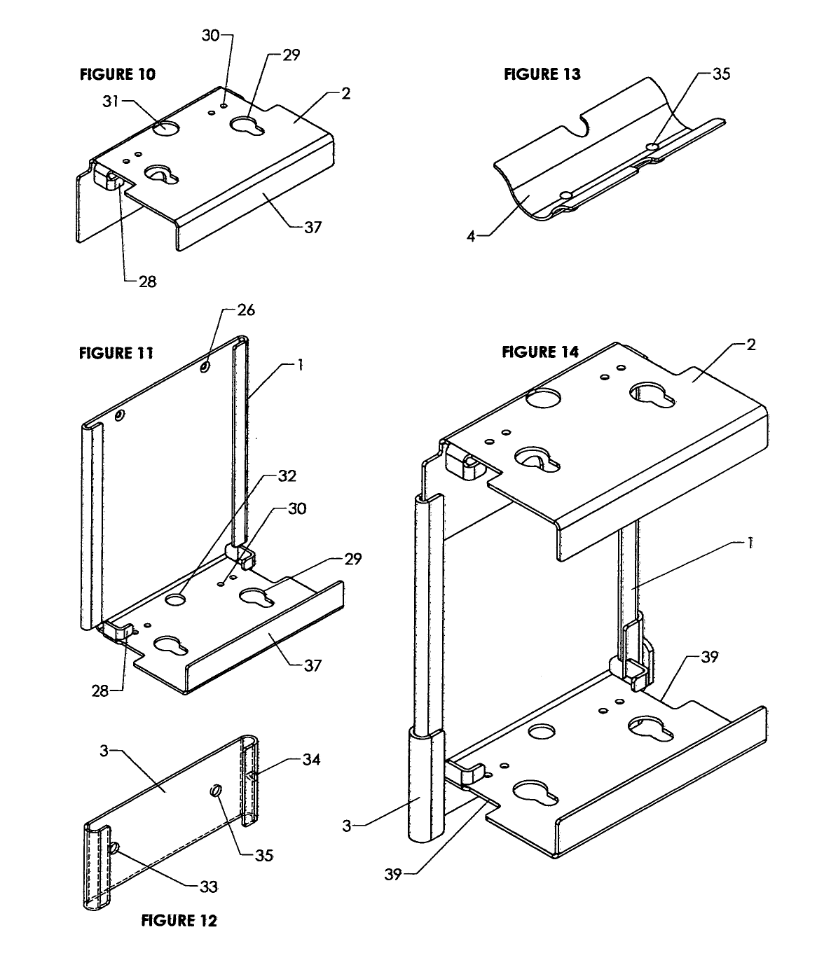

Referring to FIG. 5 12 the tool box is hung on the hanger pin 12 having a large head and the tool box adjusted to the angle of the ladder by the angle pin 19 in one of the angle slots FIG. 7 23 the set screw in FIG. 6 17 keeps the hanger bracket FIG. 6 3 as the thumb screw is tightened, into the weld nut FIG. 5 18 FIG. 5 20 is bolts on either side of the tool box to keep the paint can steady FIG. 5 15 is the tool bar and the paint pan holder tines going though the tool bar, on the edge of the tool box, on the back side of the tool box a bar in the paint pan holder is to stop the movement of the holder when in use.

Referring to FIG. 6 3 the hanger bracket shown in FIG. 14 3 is made wider than the side of the long bracket, so that the excess is formed around the sides of the long bracket as the long bracket is formed around the short bracket on the top and bottom of each side. Except not the short bracket it can move back and forth in the formed edges of the long bracket in that special formed grove, as the brackets must Pass each other in order for these brackets to tighten on the legs of ladders or scaffolds a notch is taken out of the end corner on the top and bottom of each of the brackets, giving relief for the formed edges of the brackets to pass as shown in FIG. 14 39 as, this notch is used to form a tab that is designed to protect the all thread bolt and the ladder FIG. 11 28 these brackets being referred to in claims 1, As special design of brackets.

The tool box FIG. 6 14 being hung on the hanger pin that part of the of the hanger bracket FIG. 6 3 and held in place by tightening the thumb screw FIG. 6 17. The paint pan holder made in a grill like fashion to be of light weight FIG. 6 16 using the top of the tool box in the designed location. held in place by the design of the tines as in FIG. 7 24 being curved on a special angle to go through the tool bar and the rounded end to touch the side of the tool box keeping it tight. on the top of the tool box.

Referring to FIG. 7 21 holes for paint pan holder included on both sides of the tool box because of the ability to use and change the brackets from one side of the ladder to the other, simply by loosening the all thread bolt turn it over retighten to the other side of the ladder and reverse the hanger bracket. 25 the emboss to retain the tool bar in place. FIG. 7 23 the angle slots in the head of the tool box, that when installing the tool box the ladder is usually at an angle the slot that will be used is the slot that aligns to the vertical position that causing the tool box to be level so the paint can setting in the area FIG. 7 22 will be level. The long bracket having emboss 26 at the down sloping end of the long bracket, to retain the hanger bracket from accidentally falling off. FIG. 7 24 the end tine of the paint pan holder in the cantilever position, making the area for the paint can. It also illustrates the design of the tines, which go into the tool box.

Referring to FIG. 7 the hanger bracket is the closest to the front leg of the ladder the other movements are shown in FIG. 8 and FIG. 9.

Referring to FIG. 8 arrows at the end of tool box, movement of the hanger bracket.

Referring to FIG. 9 arrows at the end of tool box, movement of the hanger bracket.

Referring to FIG. 10 2 is the blank form of the short bracket 37 being the third side of both the short and long brackets and is the retaining part of the brackets that keeps the leg of the ladder contained in the brackets. FIG. 10 31 is the weld nut mounting hole a nut is welded over this hole where the nut for the all thread bolt is welded there. FIG. 11 32 is where the all thread bolt is installed with the locking collars The hand knob on the end. FIG. 10 28 the protection tab bent to protect the all thread bolt and the ladder. This is also the same for both brackets in the corners the tops and bottoms of the brackets. FIG. 14 39 showing the notches at the corners of the brackets, both brackets having the same notches tops and bottoms of the brackets. These notches Are so that the formed parts of the brackets can pass by. FIG. 10 30 there are 4 of these holes in each bracket they are holes for rivets to hold the clips that are for the hanger pins for the two Scaffold brackets, there are 4 pins for the two brackets.

### OBJECT AND ADVANTAGE

This invention has three special formed brackets. Together they provide a way to hang the special tool box on the ladder leg, or a scaffold leg, the tool box being made to hold a gallon of paint and have the roller pan on the pan holder so you can paint by brush, roller, or have other tools next to the paint in a storage area of the tool box.

These special brackets are so simple after looking at so much of the prior art and that most of them were connected to the rungs or steps and time consuming to use, even sometimes dangerous, in that most were in some way usually connected to or connected on the steps, of which this invention eliminates.

This invention is only connected to the side of the ladder, which is a unique attachment and accessory to the ladder.

Most of the prior art could have a lot of objections but most of them had a particular use in mind when they were invented so to find them wrong is up to the craftsman using them.

What is claimed is:

1. This accessory tool box is an adapted component and held to the sides of the ladder folding ladders or scaffold legs comprising of a new design of brackets, and connected with an all thread bolt that is moveable to any area of the ladder and on either side of the ladder. The tool box comprising of several uses holding a paint can, paint pan holder, tool bar, tool storage, and connecting it through the embodiment of the three primary formed brackets. Also, a pair of special formed brackets for scaffolding that adapt into the formed brackets having slots and keyways to accept them and hold them in place.

2. As in claim 1, this accessory tool box having several uses is adapted and held to the side of the ladder and scaffold comprising of a new design of multiple brackets and connected with an all thread bolt that is moveable to any area and the tool box having several uses.

3. As in claim 1, these three brackets, comprising of two opposing brackets connected with an all thread bolt and a third bracket rides on top of the other brackets; it is the hanger bracket that has the pins that holds the tool box.

4. As in claim 1, the design of the brackets with the all thread bolt lets the brackets tighten together towards the opposite bracket or to be loosened.

5. As in claim 1, each bracket has three sides, the short of only two inches on the longest side, the long bracket is six inches on the long side.

6. As in claim 1, a smooth end of the all thread bolt is attached into the end of the long bracket and has a hand knob for tightening the all thread long bolt. The short bracket has a threaded nut in the end to be tightened towards the other bracket or loosened from the other bracket.

7. As in claim 1, the short bracket has modifications to the remaining two sides other than the two inch side, the end that has the nut for tightening the all thread bolt. It also has tabs that protect the all thread bolt and the ladder, the other very short leg is to hold the leg of the ladder into the bracket and also fit between the legs of extension ladders and as a keeper of the bracket around the leg of the ladder.

8. As in claim 1, the long bracket because it has the long leg is also wider than the short bracket. The excess width is formed around the top and bottom of the leg of the short bracket making this unique and a different type of bracket. This means that a notch must be taken from the end of the short bracket, on the top and bottom so that the two of the brackets may pass each other and this is in effect the unique part of this system in that they can not be separated in either direction because of the forming around the short bracket and the all thread bolt holding them together. The long bracket on its end also has a return around the leg of the ladder as a keeper and a tab to protect the all thread bolt and ladder.

9. As in claim 1, the next unique part of these brackets is the hanger bracket. It has two pins protruding from it, it is two inches long and also wider than the leg of the long bracket and is again formed around the long bracket in a clamping effect but able to slide along the long bracket, and it has two divots on the end to keep it on the long bracket, The hanger bracket also has a set screw on the top of it and may be held at any place on the long bracket that is wanted; the set screw can be loosened and slide the hanger bracket off, and invert it so the whole system can be used on the other side of the ladder it can only be removed on the high side of the ladder.

10. As in claim 1, the hanger bracket has a hanger pin on the top of the bracket and a straight pin on the bottom. The hanger pin has a big flat head and a small shank.

11. As in claim 1, the operation of the hanger bracket and pin is relevant to the tool box as the hole in the head of the tool box that fits over the hanger pin and slides up a short distance in a slot, the flat head of the pin restraining it in that position. The other angle pin aligns the angle of the tool box to coincide with the angle of the ladder as it fits through one of the angle slots.

12. As in claim 1, the tool box having the angle holes for the angle pin to fit through one of several slots to align with the ladder on angles so that the tool box will be held in a horizontal position.

13. As in claim 1, the two brackets with the all thread bolt are able to be placed on or slide up or down on any part of the ladder or scaffold legs.

14. As in claim 1, while the hanger bracket is able to go from the front of the ladder to the rear, so the brackets may be placed at any point on the ladder that is wanted by the craftsman with very little effort, even the changing from one side to the other side of the ladder.

15. As in claim 1, the tool box has an area for storage and an area that a paint can may be placed, and may be held there by tightening bolts that will keep it steady while being used.

16. As in claim 1, there are slots along the top of the tool box that a roller pan holder may hold a roller pan at the same time the paint can is inside the tool box. It is designed with a grill like system with slanting hooks down into the tool box and leveled across the tool box and a bar at the rear of the tool box attached to the grill of the tool box to keep it in place from the roller action while in use. The tool box has hand holes for carrying.

17. As in claim 1, the two brackets that are holding the leg of the ladder has slots and key ways in each that adapt to special made brackets that will hold onto scaffolding legs that are round and other round tube structures.

18. As in claim 1, the designed brackets are formed around the other brackets and are compact held by the encompassing design of the brackets that are held very close to the legs, of the ladder, this is a very unique design, in some instances it may not be necessary to remove them.
